(19) United States
(12) Patent Application Publication
(10) Pub. No.: US 2025/0134633 A1
(43) Pub. Date: May 1, 2025

(54) Method For Determining An Internal Structure Of A Dental Prosthesis Base, Method For The Production Of A Dental Prosthesis Base, Dental Prosthesis Base, Data-Processing Device, Computer Program And Computer-Readable Medium

(71) Applicant: Ivoclar Vivadent AG, Schaan (LI)

(72) Inventor: Hendrik JOHN, Buchs (CH)

(21) Appl. No.: 18/922,838

(22) Filed: Oct. 22, 2024

(30) Foreign Application Priority Data
Oct. 27, 2023 (EP) 23206439.4

(51) Int. Cl. A61C 9/00; A61C 13/00

(52) U.S. Cl. CPC A61C 9/0046; A61C 13/0004

(57) ABSTRACT

A method for determining an internal structure of a dental prosthesis base. The method includes obtaining outer shell data of the dental prosthesis base. Gum ridge line data are obtained. A first reference line is defined by parallel displacement of the gum ridge line or the gum ridge line is defined as a first reference line. A first reference point is defined which lies above or below the dental prosthesis base. A first separation surface is defined as a surface which comprises all straight lines which extend through the first reference point and through the first reference line. At least one sub-volume of the dental prosthesis base is deduced as volume delimited by the first separation surface and the outer shell. A dental prosthesis base is presented. A data-processing device, a computer program and a computer-readable medium are also described.

### CROSS-REFERENCE TO RELATED APPLICATIONS

This application claims priority to European patent application No. 23206439.4 filed on Oct. 27, 2023, which disclosure is incorporated herein by reference in its entirety.

### TECHNICAL FIELD

The invention relates to a method for determining an internal structure of a dental prosthesis base. The invention also relates to a method for producing a dental prosthesis base. Moreover, the invention is directed to a dental prosthesis base. Furthermore, the invention relates to a data-processing device, a computer program and a computer-readable medium.

### SUMMARY

In the context of the present invention, a dental prosthesis base is understood to be that part of a dental prosthesis which does not serve to simulate teeth. Therefore, the dental prosthesis base substantially simulates gums. Replacement teeth of a dental prosthesis do not belong to the dental prosthesis base. The dental prosthesis base can be part of a full prosthesis or a partial prosthesis.

In the field of dental prosthesis production, it is known to produce the dental prosthesis base from synthetic material. In order to simulate natural gums in a manner as true to the original as possible, the synthetic material from which the dental prosthesis base is produced can be dyed in a colour corresponding to the natural gum colour.

The object of the present invention is to further improve the level to which a dental prosthesis base is true to the original, i.e. a natural-looking appearance for the dental prosthesis base. In other words, it should become possible to produce a dental prosthesis base, the appearance of which approximates natural gums as closely as possible.

The object is achieved by a method for determining an internal structure of a dental prosthesis base. The method comprises:
obtaining outer shell data which describe an outer shell of the dental prosthesis base,
identifying a gum ridge line of the outer shell of the dental prosthesis base or obtaining gum ridge line data which describe the gum ridge line of the outer shell,
defining a first reference line by parallel displacement of the gum ridge line in the direction of an interior of the outer shell by a first displacement increment or defining the gum ridge line as a first reference line,
defining a first reference point which lies in a usage position of the dental prosthesis base above or below the dental prosthesis base,
defining a first separation surface as a surface which comprises all straight lines which extend through the first reference point and through the first reference line, and
deducing at least one sub-volume of the dental prosthesis base as a volume delimited by the first separation surface and the outer shell.

The method in accordance with the invention is based upon the observation that natural gums are not uniform in terms of their optical properties such as colour, colour brightness and/or translucency. Natural gums are brighter in colour e.g. in the region of the tooth canals because at this location the gums have thinner walls, the gum tissue at this location is often supplied with less blood and teeth show through. The natural gums are more likely to have soft colour gradients, i.e. no hard colour jumps. On this basis, the idea was developed to achieve the most natural-looking appearance possible for a dental prosthesis base not only by means of an outer shell which is as natural-looking as possible, but also by utilising the internal structure of the dental prosthesis base to achieve the most natural-looking appearance possible. Therefore, in addition to the natural-looking simulation of the outer shell, an internal structure of the dental prosthesis base is also to be selected in accordance with the present invention such that the level to which the dental prosthesis is true to the original is increased overall. The fundamental concept here is to positively influence the natural-looking appearance of the dental prosthesis base through interaction of different portions of the dental prosthesis base which have different optical properties, in particular a different colour, a different colour brightness and/or a different translucency. These different portions taken as a whole thus form the internal structure of the dental prosthesis base. The method in accordance with the invention takes account of this finding, wherein by means of this method, an internal structure of the dental prosthesis can be determined, which leads to an extremely natural-looking appearance. At the same time, the method in accordance with the invention is comparatively simple and can easily be implemented in particular within CAD software or within CAM software, The method steps thus constitute a system of rules which can be implemented in an automated manner within the CAD software or CAM software. Outer shell data which can be ascertained on a patient-specific basis are used as input data. For example, the outer shell data is based upon scan data describing an oral situation, i.e. the inside of the patient's mouth. Such scan data can be generated by means of an intraoral scanner. On the basis of such scan data, the outer shell data can be modelled within the dental CAD software and, if necessary or desired, adapted in the dental CAM software. The outer shell data describe the outer shell of the dental prosthesis base in virtual space. The method in accordance with the invention further comprises identifying a gum ridge line. In this context, a gum ridge line is understood to be a line which connects the locally highest points of the dental prosthesis base with reference to a specified dimension or direction. In the present case, the specified dimension corresponds to a depth direction of the tooth cavities of the dental prosthesis base. In dental technology, this direction is also referred to as the Z-direction. An origin lies in the centre of mass of the dental prosthesis base. The positive Z-direction is defined in parallel with a direction out of the tooth cavities. As will also be explained in greater detail hereinafter, the gum ridge line can be a labial gum ridge line or a lingual gum ridge line. In the first example, the gum ridge line is thus that line which connects the locally highest points of the dental prosthesis base on the labial side of the tooth cavities. In the second example, the gum ridge line is that line which connects the locally highest points of the dental prosthesis base on the lingual side of the tooth cavities. As an alternative to identifying the gum ridge line, it is also possible to obtain gum ridge line data which describe the gum ridge line of the outer shell. On this basis, a separation surface can be defined in a simple and reliable manner by parallel displacement of the gum ridge line, which leads to the definition of a first reference line, and by defining a reference point. Parallel displacement is effected in the negative Z-direction. As an alternative to the parallel displacement of the gum ridge line, it is possible to define the gum ridge line as a first reference line. It is understood that the definition of the first reference line, optionally the parallel displacement, the definition of the first reference point and the definition of the first separation surface are effected in virtual space. These steps can be carried out comparatively easily in an automated manner in CAD software or CAM software.

The separation surface thus divides the dental prosthesis base, which is delimited by the outer shell, into at least two portions. On this basis, at least one sub-volume can be deduced as a volume delimited by the first separation surface and the outer shell. It is likewise possible to deduce two sub-volumes which are each delimited by the first separation surface and by portions of the outer shell on either side of the first separation surface. It is understood that the delimitation of the sub-volumes by the first separation surface and the outer shell is not to be understood conclusively, i.e. the sub-volumes can also be delimited by further elements. The sub-volume or sub-volumes form the internal structure of the dental prosthesis base. The sub-volumes can be allocated materials having different optical properties. This imparts a natural appearance to the dental prosthesis base.

The first separation surface defined in the course of the method in accordance with the invention also extends obliquely when viewed along a jaw arch line, i.e. neither horizontally nor vertically in a usage position of the dental prosthesis base. As a result, when the dental prosthesis base is viewed perpendicular to the jaw arch line, portions of the dental prosthesis base which are separated from the first separation surface lie one behind the other. If a certain degree of translucency is required at least in the portion at the front in the viewing direction, the portion at the rear in the viewing direction shows through the portion at the front at least to a certain extent. This also contributes to a natural appearance of the dental prosthesis base.

In connection with that variant of the present invention in which the gum ridge line is displaced in parallel, the first displacement increment is always greater than 0 mm. In addition, the first displacement increment can be less than a maximum height of the dental prosthesis base. Preferably, the first displacement increment is several millimetres. For example, the first displacement increment is 2 to 15 mm. Preferably, the first displacement increment is 2 to 10 mm. Depending upon the application, the first displacement increment can thus be e.g. 3, 4 or 5 mm.

In particular, the method in accordance with the invention is automated, partially automated and/or computer-assisted. This means that the internal structure can be determined substantially without human activity. In this context, it is not necessary to input the displacement increments or allocate a material, a colour, a colour brightness and/or translucency. The method steps constitute a system of rules which is implemented in a computer-assisted manner. The method in accordance with the invention for determining an internal structure of a dental prosthesis base can therefore be a computer-implemented method.

It will be understood that, in conjunction with the method in accordance with the invention, terms such as “first” and “second” merely serve for simple explanation and do not imply any quantities or numbers.

It is understood that the method in accordance with the invention can be used both for partial prostheses and for full prostheses comprising a dental prosthesis base.

The method can further comprise:
defining a second reference line by parallel displacement of the gum ridge line in the direction of an interior of the outer shell by a second displacement increment, wherein the first displacement increment and the second displacement increment are different,
defining a second separation surface as a surface which comprises all straight lines which extend through the first reference point and through the second reference line, and
deducing at least one sub-volume of the dental prosthesis base as a volume delimited by the second separation surface and the outer shell.

In this variant, a second reference line is thus defined by parallel displacement of the gum ridge line by a second displacement increment. Therefore, a total of two separation surfaces can be defined, for which the same reference point, specifically the first reference point, is used. By means of the two separation surfaces, i.e. the first separation surface and the second separation surface, the outer shell of the dental prosthesis base can be divided into a total of three portions. On this basis, at least one sub-volume can be deduced. It is also possible to deduce a total of three sub-volumes, wherein a first sub-volume is delimited by the outer shell and the first separation surface and lies on a side of the first separation surface facing away from the second separation surface. A second sub-volume can be delimited by the outer shell and the second separation surface and can lie on a side of the second separation surface facing away from the first separation surface. A third sub-volume can be delimited by the first separation surface, by the second separation surface and by the outer shell. The third sub-volume lies on a side of the second separation surface facing towards the first separation surface and on a side of the first separation surface facing towards the second separation surface. These three sub-volumes do not intersect. It is understood that, of course, other sub-volumes can also be deduced using the first separation surface, the second separation surface and the outer shell. Therefore, a delicate internal structure of the dental prosthesis base can be determined. Again, the sub-volumes can be allocated materials having different optical properties. This imparts a particularly natural appearance to the dental prosthesis base.

In the context of the present invention, the second displacement increment is always greater than 0 mm. In addition, the second displacement increment can be less than a maximum height of the dental prosthesis base. Preferably, the second displacement increment is several millimetres. For example, the second displacement increment is 2 to 10 mm. Depending upon the application, the second displacement increment can thus be e.g. 2, 3, 4 or 5 mm.

Preferably, the second displacement increment can differ in terms of its magnitude from the first displacement increment. Therefore, the second displacement increment can also be defined via a difference or a delta with respect to the first displacement increment or vice versa. The difference is 2 mm to 10 mm, preferably 2 mm to 5 mm.

Alternatively, the method can further comprise:
defining a second reference line by parallel displacement of the gum ridge line in the direction of an interior of the outer shell by a second displacement increment, wherein the first displacement increment and the second displacement increment are different,
defining a second reference point which lies above or below the dental prosthesis base in a usage position of the dental prosthesis base, wherein the first reference point and the second reference point are different,
defining a second separation surface as a surface which comprises all straight lines which extend through the second reference point and through the second reference line, and
deducing at least one sub-volume of the dental prosthesis base as a volume delimited by the second separation surface and the outer shell.

In this variant, a second reference line is thus defined by parallel displacement of the gum ridge line by a second displacement increment and by defining a second reference point. Again, a total of two separation surfaces can thus be defined, for which different reference points are used, specifically the first reference point and the second reference point. By means of the two separation surfaces, i.e. the first separation surface and the second separation surface, the outer shell of the dental prosthesis base can be divided into a total of three portions. On this basis, at least one sub-volume can be deduced. It is also possible to derive a total of three sub-volumes, wherein a first sub-volume is delimited by the outer shell and the first separation surface and lies on a side of the first separation surface facing away from the second separation surface. A second sub-volume can be delimited by the outer shell and the second separation surface and can lie on a side of the second separation surface facing away from the first separation surface. A third sub-volume can be delimited by the first separation surface, by the second separation surface and by the outer shell. The third sub-volume lies on a side of the second separation surface facing towards the first separation surface and on a side of the first separation surface facing towards the second separation surface. These three sub-volumes do not intersect. It is understood that, of course, other sub-volumes can also be deduced using the first separation surface, the second separation surface and the outer shell. Therefore, a delicate internal structure of the dental prosthesis base can be determined. Again, the sub-volumes can be allocated materials having different optical properties. This imparts a particularly natural appearance to the dental prosthesis base.

As previously, the second displacement increment is preferably several millimetres. For example, the second displacement increment is 2 to 10 mm. Depending upon the application, the second displacement increment can thus be e.g. 2, 3, 4 or 5 mm. The second displacement increment can also be defined via a difference or a delta with respect to the first displacement increment. The difference is e.g. 2 mm to 10 mm, preferably 2 mm to 5 mm. As already mentioned, the first displacement increment and the second displacement increment are different.

The gum ridge line can be a labial gum ridge line or a lingual gum ridge line. The gum ridge line can be that line which connects the locally highest points of the dental prosthesis base on the labial side of the tooth cavities. Alternatively, the gum ridge line can be that line which connects the locally highest points of the dental prosthesis base on the lingual side of the tooth cavities. The method in accordance with the invention, in particular the two aforementioned variants, can be carried out using both the labial gum ridge line and the lingual gum ridge line. Therefore, it is easily possible to determine sub-volumes of the dental prosthesis base which favour a natural-looking appearance.

In one embodiment, identifying the gum ridge line comprises identifying a labial gum ridge line of the outer shell of the dental prosthesis base or obtaining labial gum ridge line data describing the labial gum ridge line of the outer shell. In addition, identifying the gum ridge line comprises identifying a lingual gum ridge line of the outer shell of the dental prosthesis base or obtaining lingual gum ridge line data describing the lingual gum ridge line of the outer shell. Moreover, the first reference line is defined by parallel displacement of the labial gum ridge line in the direction of an interior of the outer shell by the first displacement increment. Alternatively, the labial gum ridge line can be defined as the first reference line. The method further comprises:
defining a second reference line by parallel displacement of the lingual gum ridge line in the direction of an interior of the outer shell by a second displacement increment or defining the lingual gum ridge line as a second reference line,
defining a second separation surface as a surface which comprises all straight lines which extend through the first reference point and through the second reference line, and
deducing at least one sub-volume of the dental prosthesis base as a volume delimited by the second separation surface and the outer shell.

In this variant, two different gum ridge lines are thus used, specifically the labial gum ridge line and the lingual gum ridge line. On this basis, two reference lines are defined, specifically the first reference line and the second reference line. Using a common reference point, in this case the first reference point, it is thus possible to define two separation surfaces which, in this case, are referred to as the first separation surface and the second separation surface. By means of the two separation surfaces, the outer shell of the dental prosthesis base can be divided into a total of three portions. On this basis, at least one sub-volume can be deduced. It is also possible to derive a total of three sub-volumes, wherein a first sub-volume is delimited by the outer shell and the first separation surface and lies on a side of the first separation surface facing away from the second separation surface. A second sub-volume can be delimited by the outer shell and the second separation surface and can lie on a side of the second separation surface facing away from the first separation surface. A third sub-volume can be delimited by the first separation surface, by the second separation surface and by the outer shell. The third sub-volume lies on a side of the second separation surface facing towards the first separation surface and on a side of the first separation surface facing towards the second separation surface. These three sub-volumes do not intersect. It is understood that, of course, other sub-volumes can also be deduced using the first separation surface, the second separation surface and the outer shell. Therefore, a delicate internal structure of the dental prosthesis base can be determined. Again, the sub-volumes can be allocated materials having different optical properties. This imparts a particularly natural appearance to the dental prosthesis base.

According to one alternative, identifying the gum ridge line comprises identifying a labial gum ridge line of the outer shell of the dental prosthesis base or obtaining labial gum ridge line data describing the labial gum ridge line of the outer shell. Moreover, identifying the gum ridge line comprises identifying a lingual gum ridge line of the outer shell of the dental prosthesis base or obtaining lingual gum ridge line data describing the lingual gum ridge line of the outer shell. In addition, the first reference line is defined by parallel displacement of the labial gum ridge line in the direction of an interior of the outer shell by the first displacement increment. Alternatively, the labial gum ridge line can be defined as the first reference line.

### The Method Further Comprises:

defining a second reference line by parallel displacement of the lingual gum ridge line in the direction of an interior of the outer shell by a second displacement increment or defining the lingual gum ridge line as a second reference line,
defining a second reference point which lies above or below the dental prosthesis base in a usage position of the dental prosthesis base, wherein the first reference point and the second reference point are located on opposite sides of the dental prosthesis base,
defining a second separation surface as a surface which comprises all straight lines which extend through the second reference point and through the second reference line, and
deducing at least one sub-volume of the dental prosthesis base as a volume delimited by the second separation surface and the outer shell.

Again, in this variant two different gum ridge lines are used, specifically the labial gum ridge line and the lingual gum ridge line. On this basis, two reference lines are defined, specifically the first reference line and the second reference line. Furthermore, two different reference points are used, the first reference point and the second reference point. Two separation surfaces can be defined which, in this case, are referred to as the first separation surface and second separation surface. By means of the two separation surfaces, the outer shell of the dental prosthesis base can be divided into a total of three portions. On this basis, at least one sub-volume can be deduced. It is also possible to deduce a total of three sub-volumes, wherein a first sub-volume is delimited by the outer shell and the first separation surface and lies on a side of the first separation surface facing away from the second separation surface. A second sub-volume can be delimited by the outer shell and the second separation surface and can lie on a side of the second separation surface facing away from the first separation surface. A third sub-volume can be delimited by the first separation surface, by the second separation surface and by the outer shell. The third sub-volume lies on a side of the second separation surface facing towards the first separation surface and on a side of the first separation surface facing towards the second separation surface. These three sub-volumes do not intersect. It is understood that, of course, other sub-volumes can also be deduced using the first separation surface, the second separation surface and the outer shell. Therefore, a delicate internal structure of the dental prosthesis base can be determined. Again, the sub-volumes can be allocated materials having different optical properties. This imparts a particularly natural appearance to the dental prosthesis base.

According to one embodiment, the first reference point is below the dental prosthesis base in a usage position of the dental prosthesis base and the second reference point is above the dental prosthesis base in a usage position of the dental prosthesis base. Alternatively, the first reference point is above the dental prosthesis base in a usage position of the dental prosthesis base and the second reference point is below the dental prosthesis base in a usage position of the dental prosthesis base. In this regard, the region above the dental prosthesis base can be defined by a positive region of a Z-axis of the dental prosthesis base. As already explained, the Z-axis is defined by a depth direction of the tooth cavities of the dental prosthesis base. Accordingly, the region below the dental prosthesis base is defined by a negative region of the Z-axis of the dental prosthesis base. Furthermore, the region above and below the dental prosthesis base is restricted in each case by an outer periphery of the dental prosthesis base. This means that, when viewed along a direction extending oppositely to the positive Z-axis, one of the reference points lies behind the dental prosthesis base. Figuratively speaking, this reference point is therefore covered by the dental prosthesis base. In the same way, the respective other reference point lies behind the dental prosthesis base when viewed along a direction corresponding to the positive Z-axis. Figuratively speaking, this reference point is thus covered by the dental prosthesis base. It has been found that reference points defined in this way are particularly suitable for defining separation surfaces which are used to determine sub-volumes which result in a natural-looking appearance of the dental prosthesis base.

The parallel displacement can be effected along a direction which extends vertically in a usage position of the dental prosthesis base. This direction can coincide with the direction of the Z-axis. The parallel displacement is then effected along the Z-axis, preferably in the direction opposite the positive Z-direction. It has been found that reference lines defined in this way are particularly suitable for defining separation surfaces which are used to determine sub-volumes which result in a natural-looking appearance of the dental prosthesis base.

Preferably, the first reference point and/or the second reference point lie on a vertical line through a centre of mass of the outer shell of the dental prosthesis base. Alternatively, the first reference point and/or the second reference point lie on a vertical line through a centre of mass of a bounding box of the outer shell of the dental prosthesis base. In the event that a density of the dental prosthesis base is constant within the outer shell, the centre of mass coincides with a centre of volume. The same applies when there is no information relating to a density of the dental prosthesis base. A bounding box is understood to be a virtual cuboid which is placed around the outer shell of the dental prosthesis base and is just large enough to accommodate the outer shell therein. Preferably, the edges of the bounding box are oriented in parallel with the axes of a coordinate system of the dental prosthesis base. It has been found that reference points defined in this way are particularly suitable for defining separation surfaces which are used to determine sub-volumes which result in a natural-looking appearance of the dental prosthesis base.

### According to One Variant, the Method can Further Comprise:

allocating material information, colour information, colour brightness information and/or translucency information to the particular sub-volume which comprises the gum ridge line, and
allocating material information, colour information, colour brightness information and/or translucency information to a sub-volume which is separate from the gum ridge line, wherein the sub-volume which comprises the gum ridge line, and the sub-volume which is separate from the gum ridge line differ in at least one of material information, colour information, colour brightness information and translucency information.

This means that each of the sub-volumes can be allocated material information, colour information, colour brightness information and/or translucency information. In this way, the internal structure of the dental prosthesis base is defined more precisely. The fact that the sub-volume which comprises the gum ridge line, and the sub-volume which is separate from the gum ridge line differ in at least one of material information, colour information, colour brightness information and translucency information gives rise to a natural-looking appearance of the dental prosthesis base. As a whole, in this way, an internal structure of the dental prosthesis base can be defined in detail so that the dental prosthesis base has a natural-looking appearance.

The Object is Also Achieved by a Method for the Production of a Dental Prosthesis Base with a Predetermined Outer Shell. The Method Comprises:
determining an internal structure of the dental prosthesis base with at least one sub-volume by means of the method in accordance with the invention in order to determine an internal structure of a dental prosthesis base, and
fabricating the dental prosthesis base with the determined internal structure by means of substances which differ in at least one feature selected from material, colour, colour brightness and translucency.

Thus, with respect to material, colour, colour brightness and/or translucency, different substances are used to fabricate the internal structure of the dental prosthesis base. Such a dental prosthesis base is characterised by an extremely natural-looking appearance. At the same time, the method in accordance with the invention is comparatively simple and can easily be implemented in particular within a CAD-CAM workflow.

Moreover, the object is achieved by a dental prosthesis base. The dental prosthesis base has an outer shell and an internal structure, wherein the internal structure is determined by means of the method in accordance with the invention for determining an internal structure of a dental prosthesis base. The sub-volumes of the internal structure can be allocated materials having different optical properties and the sub-volumes can be produced from materials having different optical properties. This imparts a natural appearance to the dental prosthesis base.

In addition, the object is achieved by a data-processing device. The data-processing device comprises means for carrying out the method in accordance with the invention for determining an internal structure of a dental prosthesis base. Such a data-processing device can therefore be used to determine an internal structure of the dental prosthesis base which comprises at least one sub-volume. Preferably, the internal structure comprises at least two sub-volumes. These sub-volumes can be allocated materials having different optical properties. This imparts a natural appearance to the dental prosthesis base.

The object is also achieved by a computer program. The computer program comprises commands which, when the computer program is being executed by a computer, cause this computer to carry out the method in accordance with the invention for determining an internal structure of a dental prosthesis base. By using such a computer program, it is thus possible to determine an internal structure of the dental prosthesis base which comprises at least one sub-volume. Preferably, the internal structure comprises at least two sub-volumes. These sub-volumes can be allocated materials having different optical properties. This imparts a natural appearance to the dental prosthesis base. The computer program or computer program product comprises computer program code, which is stored on a non-transitory machine-readable medium, the non-transitory machine-readable medium comprising computer instructions executable by a processor, which computer instructions cause the processor to perform the method herein.

Furthermore, the object is achieved by a computer-readable medium. The computer-readable medium comprises commands which, when being executed by a computer, cause this computer to carry out the method in accordance with the invention. Such a computer-readable medium can therefore be used to determine an internal structure of the dental prosthesis base which comprises at least one sub-volume. Preferably, the internal structure comprises at least two sub-volumes. These sub-volumes can be allocated materials having different optical properties. This imparts a natural appearance to the dental prosthesis base.

### BRIEF DESCRIPTION OF THE DRAWINGS

The invention will be explained hereinafter with the aid of various exemplified embodiments which are illustrated in the attached drawings. In the drawings:

FIG. 1 shows a data-processing device in accordance with the invention having a computer-readable medium in accordance with the invention and having a computer program in accordance with the invention, wherein the data-processing device is designed to carry out a method in accordance with the invention for determining an internal structure of a dental prosthesis base and wherein the data-processing device is coupled to a production device so that a dental prosthesis base in accordance with the invention can be produced using a method in accordance with the invention for the production of a dental prosthesis base,

FIG. 2 shows a visualisation of outer shell data of a dental prosthesis base according to a first embodiment in a view along a direction II of FIG. 3, wherein elements of the method for determining an internal structure of a dental prosthesis base are also illustrated,

FIG. 3 shows a visualisation of the outer shell data of FIG. 2 in a view along a direction III of FIG. 2, wherein elements of the method for determining an internal structure of a dental prosthesis base are also illustrated,

FIG. 4 shows the dental prosthesis base in accordance with the invention according to the first embodiment in a sectional view corresponding to a view in the plane IV-IV in FIG. 3, wherein elements of the method for determining an internal structure of the dental prosthesis base are also illustrated,

FIG. 5 shows a visualisation of outer shell data of a dental prosthesis base according to a second embodiment in a view along a direction V of FIG. 6, wherein elements of the method for determining an internal structure of a dental prosthesis base are also illustrated,

FIG. 6 shows a visualisation of the outer shell data of FIG. 5 in a view along a direction V1 of FIG. 5, wherein elements of the method for determining an internal structure of a dental prosthesis base are also illustrated,

FIG. 7 shows the dental prosthesis base in accordance with the invention according to the second embodiment in a sectional view corresponding to a view in the plane VII-VII in FIG. 6, wherein elements of the method for determining an internal structure of the dental prosthesis base are also illustrated,

FIG. 8 shows the inventive dental prosthesis base of FIG. 7 in a sectional view corresponding to a view in the plane VIII-VIII in FIG. 5, wherein elements of the method for determining an internal structure of the dental prosthesis base are also illustrated,

FIG. 9 shows a dental prosthesis base in accordance with the invention according to a third embodiment in a sectional view corresponding to the views of FIGS. 4 and 7, wherein elements of the method for determining an internal structure of the dental prosthesis base are also illustrated,

FIG. 10 shows the dental prosthesis base in accordance with the invention according to a fourth embodiment in a sectional view corresponding to the views in FIGS. 4, 7 and 9, wherein elements of the method for determining an internal structure of the dental prosthesis base are also illustrated, and

FIG. 11 shows a dental prosthesis base in accordance with the invention according to a fifth embodiment in a sectional view corresponding to the views of FIGS. 4, 7, 9 and 10, wherein elements of the method for determining an internal structure of the dental prosthesis base are also illustrated.

### DETAILED DESCRIPTION

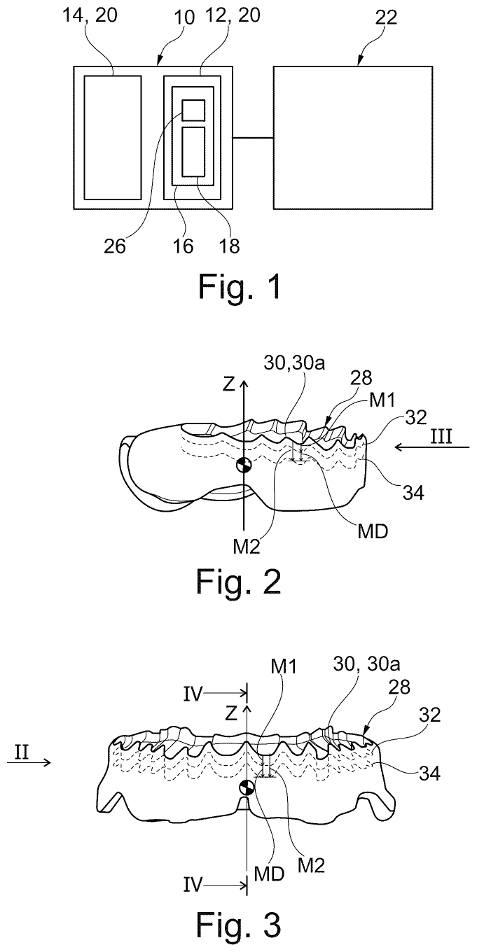

FIG. 1 shows a data-processing device 10. This comprises a memory unit 12 and a computing unit 14. The memory unit 12 comprises a computer-readable medium 16. A computer program 18 is stored on the computer-readable medium 16, i.e. also on the memory unit 12.

The computer program 18 and therefore also the computer-readable medium 16 comprise commands which, when the computer program 18 is being executed by the computing unit 14 or, more generally speaking, by a computer, cause the computing unit 14 or the computer to carry out a method for determining an internal structure of a dental prosthesis base.

Consequently, the memory unit 12 and the computing unit 14 constitute means 20 for carrying out the method for determining an internal structure of a dental prosthesis base.

In the example of FIG. 1, the data-processing device 10 is further coupled to a production device 22 by communications technology. The production device 22 is designed to produce a dental prosthesis base 24 which comprises an internal structure which has been determined by means of the method for determining the internal structure of the dental prosthesis base 24.

For this reason, the memory unit 12 in the illustrated exemplified embodiment additionally comprises a computer program 26 for actuating the production device 22. In other words, the computer program 26 comprises commands which, when the computer program 26 is being executed by the computing unit 14 or, more generally speaking, by a computer, cause the computing unit 14 or the computer to control the production device 22.

In the example of FIG. 1, the production device 22 is designed to produce the dental prosthesis base 24 additively or generatively. In simpler terms, the production device 22 can thus be designated as a 3D printer.

The method for the production of the dental prosthesis base 24 will be explained in detail hereinafter with reference to FIGS. 2 to 4. The method is characterised according to a first embodiment. The dental prosthesis base 24 which results from the application of the method is likewise characterised according to a first embodiment.

The method comprises initially determining an internal structure of the dental prosthesis base 24. A method for determining an internal structure of a dental prosthesis base 24 is used for this purpose. This method is also characterised according to a first embodiment.

A first step S1 of the method for determining an internal structure of the dental prosthesis base 24 comprises obtaining outer shell data which describe an outer shell 28 of the dental prosthesis base 24. An example of an outer shell 28 of the dental prosthesis base 24 is graphically represented in FIGS. 2 and 3.

The outer shell data can include a coordinate system which can be used to describe the outer shell data in more detail.

In such a coordinate system, the origin can be placed into a centre of mass or centre of volume of the outer shell 28. Since no information relating to a mass or density distribution within the outer shell 28 is available in the present example, the centre of mass and the centre of volume of the outer shell 28 coincide.

Furthermore, a Z-direction of the coordinate system is defined such that it extends in parallel with a depth direction of a tooth cavity of the outer shell 28. The positive direction of the Z-direction is defined in parallel with a direction which extends from a base of a tooth cavity in the direction of an opening of the tooth cavity.

The remaining axes of the coordinate system are not relevant for the following explanations and are therefore not defined in more detail.

In a second step S2, a gum ridge line 30 of the outer shell 28 is identified. In the present example, this is a labial gum ridge line 30a.

This is effected preferably in a computer-assisted manner using the data-processing device 10. The gum ridge line 30 can be identified in a fully automated manner. It is also possible for the gum ridge line 30 to be identified manually.

According to one alternative, it is alternatively possible that in the second step S2, only gum ridge line data describing the gum ridge line 30 of the outer shell 28 are obtained.

Based on this, in a third step S3, a first reference line 32 is defined by virtue of the fact that the gum ridge line 30 is displaced in parallel by a first displacement increment M1 in the direction of an interior of the outer shell 28.

The displacement is effected in a direction in parallel with the negative direction of the Z-axis.

The first displacement increment M1 is e.g. 2 mm.

The first reference line is indicated in FIG. 2 and FIG. 3, although this, of course, is not part of the outer shell data but instead is generated on the basis of the outer shell data.

In addition, a second reference line 34 is defined in a fourth step S4. Again, this is effected by means of parallel displacement of the gum ridge line 30, but this time by a second displacement increment M2. Again, the displacement is effected in the direction of an interior of the outer shell 28 and in parallel with the negative direction of the Z-axis.

The second displacement increment M2 differs from the first displacement increment and is e.g. 5 mm.

In the illustrated example, the first displacement increment M1 and the second displacement increment M2 thus differ by a delta MD of 3 mm.

The second reference line 34 is also indicated in FIG. 2 and FIG. 3, although this, of course, is not part of the outer shell data but instead is generated on the basis of the outer shell data.

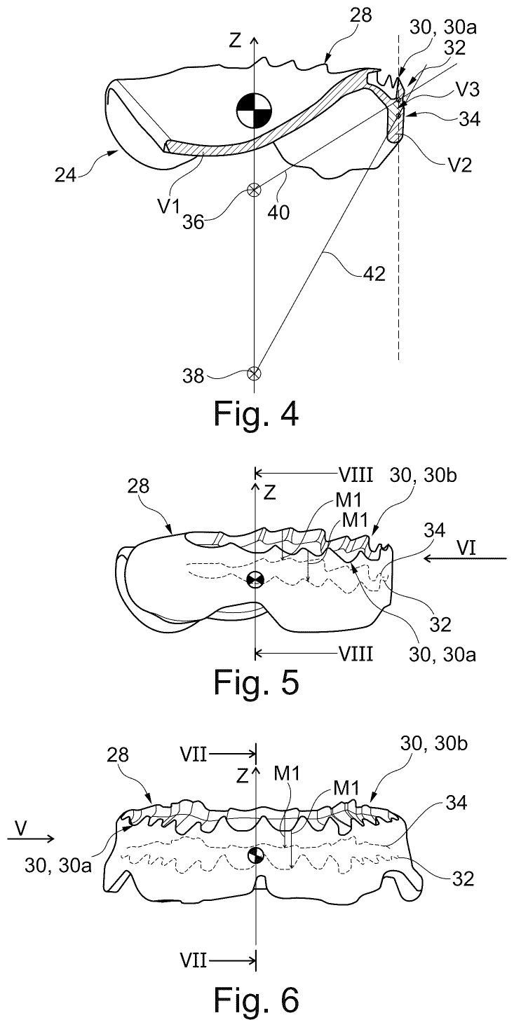

In a subsequent fifth step S5, a first reference point 36 is defined (see FIG. 4). The first reference point 36 lies on the Z-axis. In the present example, the first reference point 36 is at ca.−2 cm.

Furthermore, a second reference point 38 is defined in a sixth step S6. The second reference point 38 lies on the Z-axis. In the present example, the second reference point is at ca.−7 cm.

Thus, in the illustrated example both the first reference point 36 and the second reference point 38 are located below the dental prosthesis base 24 in a usage position of the dental prosthesis base 24. This means that both reference points 36, 38 lie in the negative range of the Z-axis.

Then, a first separation surface 40 is defined in a seventh step S7. The first separation surface 40 is defined as a surface which comprises all straight lines which extend through the first reference point 36 and through the first reference line 32.

In the same manner, a second separation surface 42 is defined in an eighth step S8. The second separation surface 42 is defined as a surface which comprises all straight lines which extend through the second reference point 38 and through the second reference line 34.

Then, sub-volumes of the dental prosthesis base 24 can be deduced in a ninth step S9.

In this context, a first sub-volume V1 is defined by the outer shell 28 and the first separation surface 40. The first sub-volume V1 thus relates to the particular portions of a volume enclosed by the outer shell 28, which lie above the first separation surface 40 in FIG. 4.

A second sub-volume V2 is delimited by the outer shell 28 and the second separation surface 42. Therefore, the second sub-volume V2 relates to the particular portions of a volume enclosed by the outer shell 28, which lie below the second separation surface 42 in FIG. 4.

A third sub-volume V3 is delimited by the first separation surface 40, the second separation surface 42 and the outer shell 28. The third sub-volume V3 thus relates to the particular portions of the volume enclosed by the outer shell 28, which lie between the first separation surface 40 and the second separation surface 42.

In a tenth step S10, each sub-volume is then allocated colour information.

In the illustrated example, the first sub-volume V1 is allocated a relatively dark colour. The first sub-volume V1 is the particular sub-volume which comprises the gum ridge line 30.

The third sub-volume V3 is allocated a relatively bright colour. The third sub-volume V3 adjoins the first sub-volume V1 but does not comprise the gum ridge line 30.

The second sub-volume V2 is allocated the same colour which has also been allocated to the first sub-volume V1, i.e. a relatively dark colour.

In addition, each of the sub-volumes V1, V2, V3 is also allocated material information, colour brightness information and translucency information.

However, in order to provide a simpler explanation, in the illustrated example the material information, the colour brightness information and the translucency information are the same for each of the sub-volumes V1, V2, V3. All sub-volumes V1, V2, V3 have a certain translucency.

This means that a portion of one of the sub-volumes V1, V2, V3 which, when viewing the dental prosthesis base 24, lies behind a portion of another one of the sub-volumes V1, V2, V3 can show through the latter.

This applies in particular when the dental prosthesis base 24 is viewed from the right in the illustration shown in FIG. 4.

By reason of the fact that both the first separation surface 40 and the second separation surface 42 extend obliquely, in such a view a portion of the third sub-volume V3 is located behind a portion of the second sub-volume V2. In the same manner, a portion of the first sub-volume V1 is arranged behind a portion of the third sub-volume V3.

The oblique progression of the first separation surface 40 and the second separation surface 42 also ensures that thicknesses of the particular portions of the first sub-volume V1, the second sub-volume V2 and the third sub-volume V3 which adjoin the first separation surface 40 and the second separation surface 42 change continuously.

For this reason, a viewer looking at the dental prosthesis base 24 from the right in the illustration shown in FIG. 4 perceives a continuous colour gradient.

The internal structure of the dental prosthesis base 24 is thus completely determined.

In a subsequent step of the method for the production of the dental prosthesis base 24, the dental prosthesis base 24 with this internal structure can be fabricated by means of materials which differ in at least one feature selected from material, colour, colour brightness and translucency. As already mentioned, in the present case the substances differ in terms of their colour.

The production device 22 can be used for this purpose.

As a result, a dental prosthesis base 24 is produced which has an outer shell 28 and an internal structure, wherein the internal structure is determined by means of the method for determining an internal structure of a dental prosthesis base 24.

In the present case, the method for determining an internal structure of the dental prosthesis base 24 using the labial gum ridge line 30a has been explained. However, according to one variant the method can be carried out in the same manner using the lingual gum ridge line. In this case, it is not the labial gum ridge line but rather the lingual gum ridge line which is displaced in parallel twice. The above explanations apply mutatis mutandis.

A variant is also feasible in which only one reference point, i.e. either the first reference point or the second reference point is used. In this variant, one of the first and second separation surfaces is thus defined using the first reference line and the first reference point, and the other separation surface is defined using the second reference line and the first reference point. Alternatively, one of the first and second separation surfaces is defined using the first reference line and the second reference point, and the other separation surface is defined using the second reference line and the second reference point.

The method for the production of the dental prosthesis base 24 can also be configured according to a second embodiment. This will be explained in detail hereinafter with reference to FIGS. 5 and 8. The dental prosthesis base 24 which results from the application of the method is thus likewise characterised according to a second embodiment.

Again, the method comprises determining an internal structure of the dental prosthesis base 24. A method for determining an internal structure of a dental prosthesis base 24 according to a second embodiment is used for this purpose.

Again, a first step S1 of the method for determining an internal structure of the dental prosthesis base 24 comprises obtaining outer shell data which describe an outer shell 28 of the dental prosthesis base 24. An example of an outer shell 28 of the dental prosthesis base 24 is graphically represented in FIGS. 5 and 6.

Again, the outer shell data can comprise a coordinate system which is defined in the same manner as in the case of the first embodiment.

In a second step S2, a labial gum ridge line 30a and a lingual gum ridge line 30b of the outer shell 28 are identified. In contrast to the method according to the first embodiment, a total of two gum ridge lines 30 are identified.

This is effected preferably in a computer-assisted manner using the data-processing device 10. The gum ridge lines 30a, 30b can be identified in a fully automated manner. It is also possible for the gum ridge lines 30a, 30b to be identified manually.

According to one alternative, it is likewise possible that in the second step S2, only gum ridge line data describing the gum ridge lines 30a, 30b of the outer shell 28 are obtained.

Based on this, in a third step S3, a first reference line 32 is defined by virtue of the fact that the labial gum ridge line 30a is displaced in parallel by a first displacement increment M1 in the direction of an interior of the outer shell 28.

The displacement is effected in a direction in parallel with the negative direction of the Z-axis.

The first displacement increment M1 is e.g. 5 mm.

The first reference line 32 is indicated in FIG. 5 and FIG. 6, although this, of course, is not part of the outer shell data but instead is generated on the basis of the outer shell data.

In addition, a second reference line 34 is defined in a fourth step S4. This is effected by a parallel displacement of the lingual gum ridge line 30b, wherein the displacement is effected in a direction in parallel with the negative direction of the Z-axis and the first displacement increment M1 is likewise used. The lingual gum ridge line 30b is also displaced in parallel by 5 mm.

The second reference line 34 is also indicated in FIG. 5 and FIG. 6, although this, of course, is not part of the outer shell data but instead is generated on the basis of the outer shell data.

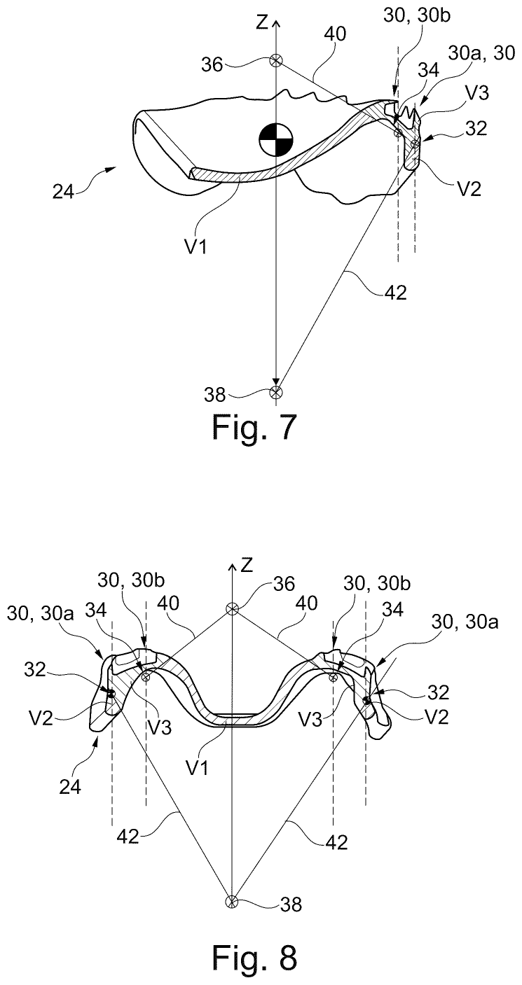

In a subsequent fifth step S5, a first reference point 36 is defined. The first reference point 36 lies on the Z-axis. In the present example, the first reference point is at ca. +2 cm. This is in contrast to the preceding embodiment on the positive Z-axis (see FIGS. 7 and 8).

Furthermore, a second reference point 38 is defined in a sixth step S6. The second reference point 38 lies on the Z-axis. In the present example, the second reference point is at ca.−7 cm.

Thus, in the illustrated example, in a usage position of the dental prosthesis base 24 the first reference point 36 is located above the dental prosthesis base and the second reference point 38 is located below the dental prosthesis base 24.

Then, a first separation surface 40 is defined in a seventh step S7. The first separation surface 40 is defined as a surface which comprises all straight lines which extend through the first reference point 36 and through the first reference line 32.

In the same manner, a second separation surface 42 is defined in an eighth step S8. The second separation surface 42 is defined as a surface which comprises all straight lines which extend through the second reference point 38 and through the second reference line 34. Then, sub-volumes of the dental prosthesis base can be deduced in a ninth step S9.

In this context, a first sub-volume V1 is defined by the outer shell 28 and the first separation surface 40. The first sub-volume V1 thus relates to the particular portions of a volume enclosed by the outer shell 28, which lie below the first separation surface 40 in FIGS. 7 and 8. It should be noted that the first separation surface 40 thus intersects the volume defined by the outer shell 28 only once.

More generally speaking, in cases in which the first separation surface 40 and the volume defined by the outer shell 28 have a plurality of mutually separate intersections, only the particular intersection which lies closest to the first reference point 36 is taken into consideration. The same applies to the second separation surface 42 and the second reference point 38, where appropriate.

A second sub-volume V2 is delimited by the outer shell 28 and the second separation surface 42. Consequently, the second sub-volume V2 relates to the particular portions of a volume enclosed by the outer shell 28, which lie below the second separation surface 42 in FIGS. 7 and 8.

A third sub-volume V3 is delimited by the first separation surface 40, the second separation surface 42 and the outer shell 28. The third sub-volume V3 thus relates to the particular portions of the volume enclosed by the outer shell 28, which lie between the first separation surface 40 and the second separation surface 42.

In a tenth step S10, each of the sub-volumes is then allocated colour information.

In the illustrated example, the first sub-volume V1 is allocated a relatively dark colour. In the present embodiment, the first sub-volume V1 is a sub-volume which is separate from the gum ridge lines 30a, 30b, i.e. it does not comprise any of the gum ridge lines 30a, 30b.

The third sub-volume V3 is allocated a relatively bright colour. The third sub-volume V3 adjoins the first sub-volume V1. In the present embodiment, the third sub-volume V3 comprises both the labial and also the lingual gum ridge line 30a, 30b.

The second sub-volume V2 is allocated the same colour which has also been allocated to the first sub-volume V1, i.e. a relatively dark colour.

In addition, each of the sub-volumes V1, V2, V3 is also allocated material information, colour brightness information and translucency information.

However, in order to provide a simpler explanation, in the illustrated example the material information, the colour brightness information and the translucency information are the same for each of the sub-volumes V1, V2, V3. All sub-volumes V1, V2, V3 have a certain translucency.

This means that a portion of one of the sub-volumes V1, V2, V3 which, when viewing the dental prosthesis base 24, lies behind a portion of another one of the sub-volumes V1, V2, V3 can show through the latter.

This applies in particular when the dental prosthesis base 24 is viewed from the right in the illustration shown in FIG. 7 and from the left or right in the illustration shown in FIG. 8.

By reason of the fact that both the first separation surface 40 and the second separation surface 42 extend obliquely, in such a view a portion of the third sub-volume V3 is located behind a portion of the second sub-volume V2. In the same manner, a portion of the first sub-volume V1 is arranged behind a portion of the third sub-volume V3.

The oblique progression of the first separation surface 40 and the second separation surface 42 also ensures that thicknesses of the particular portions of the first sub-volume V1, the second sub-volume V2 and the third sub-volume V3 which adjoin the first separation surface 40 and the second separation surface 42 change continuously.

For this reason, a viewer looking at the dental prosthesis base 24 from the right in the illustration shown in FIG. 7 and from the left or right in the illustration shown in FIG. 8 perceives a continuous colour gradient.

The internal structure of the dental prosthesis base 24 is thus completely determined.

In a subsequent step of the method for the production of the dental prosthesis base 24, the dental prosthesis base 24 with this internal structure can be fabricated by means of materials which differ in at least one feature selected from material, colour, colour brightness and translucency. As already mentioned, in the present case the substances differ in terms of their colour.

The production device 22 can be used for this purpose.

As a result, a dental prosthesis base 24 is produced which has an outer shell 28 and an internal structure, wherein the internal structure is determined by means of the method for determining an internal structure of a dental prosthesis base 24.

Although two reference points, specifically the first reference point 36 and the second reference point 38, were used in the method according to the second embodiment, a variant is feasible in which only one reference point, i.e. either the first reference point 36 or the second reference point 38, is used. In this variant, one of the first separation surface 40 and second separation surface 42 is thus defined using the first reference line 32 and the first reference point 36, and the other of the first separation surface 40 and second separation surface 42 is defined using the second reference line 34 and the first reference point 36. Alternatively, one of the first separation surface 40 and second separation surface 42 is defined using the first reference line 32 and the second reference point 38, and the other of the first separation surface 40 and second separation surface 42 is defined using the second reference line 34 and the second reference point 38.

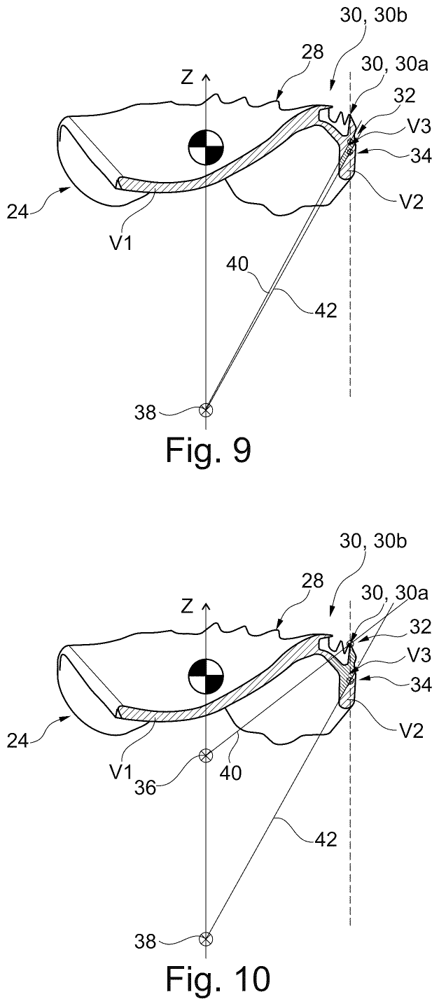

The method for the production of the dental prosthesis base 24 can also be configured according to a third embodiment. This will be explained in detail hereinafter with reference to FIG. 9. The dental prosthesis base 24 which results from the application of the method is thus likewise characterised according to a third embodiment.

Again, the method comprises determining an internal structure of the dental prosthesis base 24. A method for determining an internal structure of a dental prosthesis base 24 according to a third embodiment is used for this purpose.

In the present case, the method for determining an internal structure of a dental prosthesis base 24 according to the third embodiment represents a variant of the method for determining an internal structure of a dental prosthesis base 24 according to the first embodiment. Therefore, only the differences between the first and third embodiments will be discussed hereinafter.

The method for determining an internal structure of a dental prosthesis base 24 according to the third embodiment thus differs from the first embodiment in that only a single reference point is used instead of two reference points.

Proceeding from the first embodiment shown in FIG. 4, only the second reference point 38 is used in the third embodiment shown in FIG. 9.

The first separation surface 40 is thus defined using the second reference point 38 and the first reference line 32. The second separation surface 42 is defined using the second reference point 38 and the second reference line 34.

For the remainder, reference is made to the above explanations relating to the method for determining an internal structure of a dental prosthesis base 24 according to the first embodiment.

In the present case, the method for determining an internal structure of the dental prosthesis base 24 according to the third embodiment using the labial gum ridge line 30a has been explained and illustrated. However, according to one variant the method can be carried out in the same manner using the lingual gum ridge line 30b. In this case, it is not the labial gum ridge line 30a but rather the lingual gum ridge line 30b which is displaced in parallel twice. The above explanations apply mutatis mutandis.

The method for the production of the dental prosthesis base 24 can also be configured according to a fourth embodiment. This will be explained in detail hereinafter with reference to FIG. 10. The dental prosthesis base 24 which results from the application of the method is thus likewise characterised according to a fourth embodiment.

Again, the method comprises determining an internal structure of the dental prosthesis base 24. A method for determining an internal structure of a dental prosthesis base 24 according to a fourth embodiment is used for this purpose.

In the present case, the method for determining an internal structure of a dental prosthesis base 24 according to the fourth embodiment represents a variant of the method for determining an internal structure of a dental prosthesis base 24 according to the first embodiment. Therefore, only the differences between the first and fourth embodiments will be discussed hereinafter.

The difference is that the first reference line 32 is determined by virtue of the fact that the labial gum ridge line 30a is defined as the first reference line 32.

As in the first embodiment, the second reference line 34 is defined by a parallel displacement of the labial gum ridge line 30a.

For the remainder, reference is made to the above explanations relating to the method for determining an internal structure of a dental prosthesis base 24 according to the first embodiment.

In the present case, the method for determining an internal structure of the dental prosthesis base 24 according to the fourth embodiment using the labial gum ridge line 30a has been explained and illustrated. However, according to one variant the method can be carried out in the same manner using the lingual gum ridge line 30b. In this case, it is not the labial gum ridge line 30a but rather the lingual gum ridge line 30b which is displaced in parallel once and is defined as the reference line once. The above explanations apply mutatis mutandis.

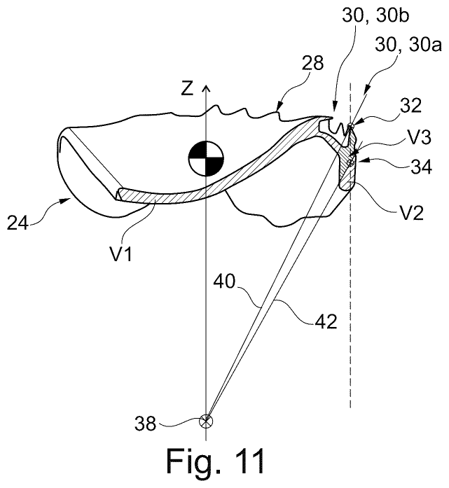

The method for the production of the dental prosthesis base 24 can also be configured according to a fifth embodiment. This will be explained in detail hereinafter with reference to FIG. 11. The dental prosthesis base 24 which results from the application of the method is thus likewise characterised according to a fifth embodiment.

Again, the method comprises determining an internal structure of the dental prosthesis base 24. A method for determining an internal structure of a dental prosthesis base 24 according to a fifth embodiment is used for this purpose.

In the present case, the method for determining an internal structure of a dental prosthesis base 24 according to the fifth embodiment represents a combination of the method for determining an internal structure of a dental prosthesis base 24 according to the third embodiment and according to the fourth embodiment. Likewise, the method for determining an internal structure of a dental prosthesis base 24 according to the fifth embodiment can be considered to be a variant of the method for determining an internal structure of a dental prosthesis base 24 according to the first embodiment.

In contrast to the first embodiment, in the fifth embodiment the first reference line 32 is thus determined by virtue of the fact that the labial gum ridge line 30a is defined as the first reference line 32.

As in the first embodiment, the second reference line 34 is defined by a parallel displacement of the labial gum ridge line 30a.

Furthermore, in the fifth embodiment only a single reference point is used instead of two reference points.

Proceeding from the first embodiment shown in FIG. 4, only the second reference point 38 is used in the fifth embodiment shown in FIG. 11.

The first separation surface 40 is thus defined using the second reference point 38 and the first reference line 32. The second separation surface 42 is defined using the second reference point 38 and the second reference line 34.

For the remainder, reference is made to the above explanations relating to the method for determining an internal structure of a dental prosthesis base 24 according to the first embodiment.

In the present case, the method for determining an internal structure of the dental prosthesis base 24 according to the fifth embodiment using the labial gum ridge line 30a has been explained and illustrated. However, according to one variant the method can be carried out in the same manner using the lingual gum ridge line 30b. In this case, it is not the labial gum ridge line 30a but rather the lingual gum ridge line 30b which is displaced in parallel once and is defined as the reference line once. The above explanations apply mutatis mutandis.

It is also understood that the above embodiments can also be combined.

### LIST OF REFERENCE SIGNS

10 data-processing device
12 memory unit
14 computing unit
16 computer-readable medium
18 computer program
20 means for carrying out a method for determining an internal structure of a dental
prosthesis base
22 production device
24 dental prosthesis base
26 computer program
28 outer shell
30 gum ridge line
30a labial gum ridge line
30b lingual gum ridge line
32 first reference line
34 second reference line
36 first reference point
38 second reference point
40 first separation surface
42 second separation surface
M1 first displacement increment
M2 second displacement increment
MD delta of the first displacement increment and the second displacement increment
S1 first step
S2 second step
S3 third step
S4 fourth step
S5 fifth step
S6 sixth step
S7 seventh step
5 S8 eighth step
S9 ninth step
S10 tenth step
V1 first sub-volume
V2 second sub-volume
V3 third sub-volume

1. A method for determining an internal structure of a dental prosthesis base (24), comprising:
obtaining outer shell data which describe an outer shell (28) of the dental prosthesis base (24) (S1),
identifying a gum ridge line (30, 30a, 30b) of the outer shell (28) of the dental prosthesis base (28) or obtaining gum ridge line data which describe the gum ridge line (30, 30a, 30b) of the outer shell (28) (S2),
defining a first reference line (32) by parallel displacement of the gum ridge line (30, 30a, 30b) in the direction of an interior of the outer shell (28) by a first displacement increment (M1) or defining the gum ridge line (30, 30a, 30b) as a first reference line (32) (S3),
defining a first reference point (36) which lies in a usage position of the dental prosthesis base (24) above or below the dental prosthesis base (24) (S5),
defining a first separation surface (40) as a surface which comprises all straight lines which extend through the first reference point (36) and through the first reference line (32) (S7), and
deducing at least one sub-volume (V1, V3) of the dental prosthesis base (24) as a volume delimited by the first separation surface (40) and the outer shell (28) (S9).

2. The method as claimed in claim 1, further comprising
defining a second reference line (34) by parallel displacement of the gum ridge line (30, 30a, 30b) in the direction of an interior of the outer shell (28) by a second displacement increment (M2), wherein the first displacement increment (M1) and the second displacement increment (M2) are different (S4),
defining a second separation surface (42) as a surface which comprises all straight lines which extend through the first reference point (32) and through the second reference line (34) (S8), and
deducing at least one sub-volume (V2, V3) of the dental prosthesis base (24) as a volume delimited by the second separation surface (42) and the outer shell (28) (S9).

3. The method as claimed in claim 1, further comprising
defining a second reference line (34) by parallel displacement of the gum ridge line (30, 30a, 30b) in the direction of an interior of the outer shell (28) by a second displacement increment (M2), wherein the first displacement increment (M1) and the second displacement increment (M2) are different (S4),
defining a second reference point (38) which lies above or below the dental prosthesis base in a usage position of the dental prosthesis base (24), wherein the first reference point (36) and the second reference point (38) are different (S6),
defining a second separation surface (42) as a surface which comprises all straight lines which extend through the second reference point (38) and through the second reference line (34) (S8), and
deducing at least one sub-volume (V2, V3) of the dental prosthesis base (24) as a volume delimited by the second separation surface (42) and the outer shell (28) (S9).

4. The method as claimed in claim 1,
wherein the gum ridge line (30, 30a, 30b) is a labial gum ridge line (30a), or
wherein the gum ridge line (30, 30a, 30b) is a lingual gum ridge line (30b).

5. The method as claimed in claim 1,
wherein identifying the gum ridge line (30, 30a, 30b) comprises identifying a labial gum ridge line (30a) of the outer shell (28) of the dental prosthesis base (24) or obtaining labial gum ridge line data describing the labial gum ridge line (30a) of the outer shell (28),
wherein identifying the gum ridge line (30, 30a, 30b) comprises identifying a lingual gum ridge line (30b) of the outer shell (28) of the dental prosthesis base (28) or obtaining lingual gum ridge line data describing the lingual gum ridge line (30b) of the outer shell (28),
wherein the first reference line (32) is defined by parallel displacement of the labial gum ridge line (30a) in the direction of an interior of the outer shell (28) by the first displacement increment (M1) or wherein the labial gum ridge line (30a) is defined as the first reference line (32),
wherein the method further comprises:
defining a second reference line (34) by parallel displacement of the lingual gum ridge line (30b) in the direction of an interior of the outer shell (28) by a second displacement increment (M2) or defining the lingual gum ridge line (30b) as a second reference line (34) (S4),
defining a second separation surface (42) as a surface which comprises all straight lines which extend through the first reference point (36) and through the second reference line (34) (S8), and
deducing at least one sub-volume (V2, V3) of the dental prosthesis base (24) as a volume delimited by the second separation surface (42) and the outer shell (28) (S9).

6. The method as claimed in claim 1,
wherein identifying the gum ridge line (30, 30a, 30b) comprises identifying a labial gum ridge line (30a) of the outer shell (28) of the dental prosthesis base (24) or obtaining labial gum ridge line data describing the labial gum ridge line (30a) of the outer shell (28),
wherein identifying the gum ridge line (30, 30a, 30b) comprises identifying a lingual gum ridge line (30b) of the outer shell (28) of the dental prosthesis base (24) or obtaining lingual gum ridge line data describing the lingual gum ridge line (30b) of the outer shell (28),
wherein the first reference line (32) is defined by parallel displacement of the labial gum ridge line (30a) in the direction of an interior of the outer shell (28) by the first displacement increment (M1) or wherein the labial gum ridge line (30a) is defined as the first reference line (32),
wherein the method further comprises:
defining a second reference line (34) by parallel displacement of the lingual gum ridge line (30b) in the direction of an interior of the outer shell (28) by a second displacement increment (M2) or defining the lingual gum ridge line (30b) as a second reference line (34) (S4),
defining a second reference point (38) which lies above or below the dental prosthesis base (24) in a usage position of the dental prosthesis base (24), wherein the first reference point (36) and the second reference point (38) are located on opposite sides of the dental prosthesis base (24) (S6),
defining a second separation surface (42) as a surface which comprises all straight lines which extend through the second reference point (38) and through the second reference line (34) (S8), and
deducing at least one sub-volume (V2, V3) of the dental prosthesis base (24) as a volume delimited by the second separation surface (42) and the outer shell (28) (S9).

7. The method as claimed in claim 6,
wherein the first reference point (36) lies below the dental prosthesis base (24) in a usage position of the dental prosthesis base (24) and wherein the second reference point (38) lies above the dental prosthesis base (24) in a usage position of the dental prosthesis base (24), or
wherein the first reference point (36) lies above the dental prosthesis base (24) in a usage position of the dental prosthesis base (24) and wherein the second reference point (38) lies below the dental prosthesis base (24) in a usage position of the dental prosthesis base (24).

8. The method as claimed in claim 1,
wherein the parallel displacement is effected along a direction which extends vertically in a usage position of the dental prosthesis base (24).

9. The method as claimed in claim 2,
wherein the first reference point (36) and/or the second reference point (38) lies on a vertical through a centre of mass of the outer shell (28) of the dental prosthesis base (24) or wherein the first reference point (36) and/or the second reference point (38) lies on a vertical through a centre of mass of a bounding box of the outer shell (28) of the dental prosthesis base (24).

10. The method as claimed in claim 1, further comprising
allocating material information, colour information, colour brightness information and/or translucency information to the particular sub-volume (V1, V2, V3) which comprises the gum ridge line (30, 30a, 30b), and
allocating material information, colour information, colour brightness information and/or translucency information to a sub-volume (V1, V2, V3) which is separate from the gum ridge line (30, 30a, 30b), wherein the sub-volume (V1, V2, V3) which comprises the gum ridge line (30, 30a, 30b), and the sub-volume (V1, V2, V3) which is separate from the gum ridge line (30, 30a, 30b) differ in at least one of material information, colour information, colour brightness information and translucency information (S10).

11. A method for the production of a dental prosthesis base (24) with a predetermined outer shell (28), comprising:
determining an internal structure of the dental prosthesis base (24) with at least one sub-volume (V1, V2, V3) by the method as claimed in claim 1, and
fabricating the dental prosthesis base (24) with the determined internal structure by substances which differ in at least one feature selected from material, colour, colour brightness and translucency.

12. A dental prosthesis base (24) comprising
an outer shell (28) and
an internal structure,
wherein the internal structure is determined by the method as claimed in claim 1.

13. A data-processing device (10) comprising means (20) for carrying out the method as claimed in claim 1.

14. A computer program (18) product comprising computer program code which is stored on a non-transitory machine-readable medium, the non-transitory machine-readable medium comprising computer instructions executable by a processor, which computer instructions cause the processor to perform the method as claimed in claim 1.

15. A non-transitory machine-readable medium (16) comprising commands, which, when executed by a computer, cause the computer to carry out the method as claimed in claim 1.
